(19) United States
(12) Patent Application Publication
(10) Pub. No.: US 2014/0356681 A1
(43) Pub. Date: Dec. 4, 2014

(54) BRAZING STRUCTURE, AND RELATED PROCESSES AND DEVICES

(71) Applicant: General Electric Company, Schenectady, NY (US)

(72) Inventors: Sundeep Kumar, Bangalore (IN); Mohamed Rahmane, Ballston Lake, NY (US); Vipin Raju Suddala, Bangalore (IN)

(73) Assignee: General Electric Company, Schenectady, NY (US)

(21) Appl. No.: 13/907,017

(22) Filed: May 31, 2013

(51) Int. Cl. H01M 10/39; B23K 1/19; B23K 1/20; B23K 1/00

(52) U.S. Cl. CPC H01M 10/399; B23K 1/0016; B23K 1/19; B23K 1/20; B23K 2001/12; H01M 2300/0068
USPC 429/104; 228/124.5; 403/272

(57) ABSTRACT

A brazing structure for an electrochemical cell is described. It includes a nickel or nickel alloy component; a ceramic component; a braze alloy layer, containing an active metal element, between the nickel and the ceramic component, and a barrier layer disposed between the nickel layer and the braze alloy layer. The barrier layer is capable of preventing or minimizing the diffusion of the active metal element into the nickel or nickel alloy component. Electrochemical cells that include such a brazing structure are also described, as are related methods for joining nickel components to ceramic components in the manufacture of thermal batteries.

### TECHNICAL FIELD

This invention generally relates to brazing structures and compositions. In some particular embodiments, it relates to energy storage devices, such as batteries, that include brazing structures.

### BACKGROUND OF THE INVENTION

Metal chloride batteries, especially sodium-metal chloride batteries with a molten sodium negative electrode (usually referred to as the anode) and a beta-alumina solid electrolyte, are of considerable interest for energy storage applications. In addition to the anode, the batteries include a positive electrode (usually referred to as the cathode) that supplies/receives electrons during the charge/discharge of the battery. The solid electrolyte functions as the membrane or “separator” between the anode and the cathode.

When these metal chloride batteries are employed in mobile applications like hybrid locomotives or plug-in electric vehicles (PHEV), the batteries are often capable of providing power surges (high currents) during the discharge cycle. In an ideal situation, the battery power can be achieved without a significant loss in the working capacity and the cycle life of the battery. The advantageous features of these types of batteries provide opportunities for applications in a number of other areas as well. Examples include their incorporation into uninterruptable power supply (UPS) devices; or as part of a battery backup system for a telecommunications (“telecom”) device, sometimes referred to as a telecommunication battery backup system (TBS).

A typical, general design for metal chloride cells and other types of thermal batteries is depicted in FIG. 3, which will be explained in the detailed description. These batteries usually include a number of compartments and regions for containing, delivering, or receiving the electrochemical components needed for battery reactions, e.g., electrode and electrolyte components. Sealing systems are needed to prevent electrochemical materials from travelling from one compartment to another, as well as preventing materials like liquid sodium from leaking out of the battery cell. Since the batteries, when in use, operate at relatively high temperatures, but also require long-life capabilities, seal integrity can be critical.

Many types of seal materials and sealing systems have been considered for use in high-temperature rechargeable batteries/cells for joining different components. Sodium/sulfur or sodium/metal halide cells generally include several ceramic and metal components. The ceramic components usually include an electrically insulating alpha-alumina collar, and an ion-conductive electrolyte beta-alumina tube, and are generally joined or bonded via a sealing glass. The metal components include a metallic casing, current collector components, and other metallic components which are often joined by welding or thermal compression bonding (TCB). However, metal-to-ceramic bonding can sometimes present some difficulty, mainly due to thermal stress caused by a mismatch in the coefficient of thermal expansion for the ceramic and metal components. The formation of strong, leak-proof, reliable seals between metal and ceramic parts can be a very challenging prospect.

“Active brazing” techniques have been developed to improve the joining of ceramics to metals, as well as ceramic materials to other ceramic materials. Active brazing uses an active metal element that promotes wetting of a ceramic surface, enhancing the capability of providing a hermetic seal, e.g., one capable of containing battery constituents within interior regions of the device. An “active metal element”, as used herein, refers to a reactive metal that has high affinity to the oxygen within the ceramic, and thereby reacts with the ceramic. A braze alloy containing an active metal element can also be referred to as an “active braze alloy.” The active metal element undergoes a decomposition reaction with the ceramic, when the braze alloy is in a molten state, and leads to the formation of a thin reaction layer on the interface of the ceramic and the braze alloy. The thin reaction layer allows the braze alloy to wet the ceramic surface, resulting in the formation of a ceramic-ceramic or a ceramic-metal joint or bond, which may also be referred to as an “active braze seal.”

The type of active metal element (usually one of titanium (Ti), zirconium (Zr), hafnium (Hf), or vanadium (V)) in the braze alloy for a particular type of braze bond can be important. The active metal must form a continuous reaction layer, to ensure a strong, hermetic joint. Moreover, the composition of the components being joined together is also an important consideration in forming a desired hermetic joint.

The joining of aluminum oxide (alumina) components to nickel metal components by active brazing techniques can sometimes present some difficulties. During the brazing process, at elevated temperatures, active elements like titanium sometimes diffuse in the molten state toward nickel, at a rate faster than diffusion toward the alumina component. Diffusion in this manner effectively deprives the alumina of the necessary titanium content. In some cases, this can lead to an inferior brazed joint, which can, in turn, lead to failure of the particular seal. Various other metals may be as susceptible to this diffusion problem, as in the case of nickel. However, the predominant use of nickel in various electrochemical devices like thermal batteries demonstrates that the problem can be a serious one.

Thus, new methods for ensuring that very strong and hermetic braze seals can be formed between various metal and ceramic components, would be welcome in the art. The methods and related brazed structures should be effective for providing strong seals between various ceramic components and nickel components, e.g., when those components are used for sealing structures in high-performance, thermal batteries. Moreover, the methods should not adversely affect the performance of devices which include the sealing structures, in any significant way.

### BRIEF DESCRIPTION

An embodiment of the invention is directed to a brazing structure for a thermal battery, comprising:

a) a nickel or nickel alloy component;

b) a ceramic component;

c) a braze alloy layer disposed between components (a) and (b), and formed of a composition comprising an active metal element; and

d) a barrier layer disposed between component (a) and the braze alloy layer, capable of preventing or minimizing the diffusion of the active metal element into the nickel or nickel alloy component.

Another embodiment relates to an electrochemical cell that includes at least one ceramic component and at least one metallic component that comprises nickel or a nickel alloy. The components are joined to each other by a braze alloy composition that comprises an active metal element. A barrier layer is disposed between the metallic component and the braze alloy composition, said barrier layer being capable of preventing or minimizing the diffusion of the active metal element into the metallic component.

A method of joining a nickel or nickel alloy (metallic) component in a thermal battery to a ceramic component in the battery, constitutes another embodiment of the invention. The method includes the steps of:

(I) applying a barrier layer to at least a portion of the surface of the metallic component;

(II) introducing an active metal-containing braze alloy composition between the barrier layer and the ceramic component to be joined; and

(III) heating the components and the braze alloy composition to form an active braze seal (joint) between the metallic component and the ceramic component.

The barrier layer is capable of preventing or minimizing the diffusion of the active metal into the metallic component.

These and other features, aspects, and advantages of the present invention will become better understood when the following detailed description is read, with reference to the accompanying drawings.

### BRIEF DESCRIPTION OF DRAWINGS

FIG. 1 is a cross-sectional depiction of a brazing structure that includes a ceramic component joined to a metal component, according to some embodiments of the prior art.

FIG. 2 is a cross-sectional depiction of a brazing structure that includes a ceramic component joined to a metal component, according to embodiments of the present invention.

FIG. 3 is a schematic view showing a cross-section of an electrochemical cell that includes features according to some embodiments of the present invention.

FIG. 4 is a schematic, view showing a cross-section of a portion of an electrochemical cell according to embodiments of the present invention.

FIG. 5 is a micrograph depicting a ceramic-metal structure, after a brazing step, according to some embodiments of the prior art.

FIG. 6 is a micrograph depicting a portion of a ceramic-metal structure, after a brazing step, according to some embodiments of the present invention.

### DETAILED DESCRIPTION

When introducing elements of various embodiments of the present invention, the articles “a,” “an,” “the,” and “said” are intended to mean that there are one or more of the elements, unless otherwise indicated. Moreover, the terms “comprising,” “including,” and “having” are intended to be inclusive, and mean that there may be additional elements other than the listed elements. As used herein, the term “and/or” includes any and all combinations of one or more of the associated listed items. Furthermore, unless otherwise indicated herein, the terms “disposed on”, “deposited on” or “disposed between” refer to both direct contact between layers, objects, and the like, or indirect contact, e.g., having intervening layers therebetween.

Approximating language, as used herein throughout the specification and claims, may be applied to modify any quantitative representation that could permissibly vary without resulting in a change in the basic function to which it may be related. Accordingly, a value modified by a term such as “about” is not limited to the precise value specified. In some instances, the approximating language may correspond to the precision of an instrument for measuring the value.

As described previously, the brazing structure for embodiments of this invention includes a metal component like nickel (or nickel alloys), joined to a ceramic component, by the use of a braze alloy material disposed between the two components. The ceramic component is often alumina, but other ceramics are possible as well, such as zirconia, titania, silicon carbide, spinel, magnesium oxide, yttria, and yttria aluminum garnet (YAG). As further described elsewhere herein, the ceramic and metal components are often (but not always) in the form of parts used in electrochemical devices, such as batteries.

A wide variety of brazing compositions may be used for the present invention. Some are described, for example, in pending U.S. application Ser. No. 13/407,870 (Docket 254898), filed on Feb. 29, 2012; and in U.S. application Ser. No. 13/538,203 (Docket 256606-2), filed on Jun. 29, 2012, both of which are incorporated herein by reference. The braze alloy compositions often comprise nickel, the active metal element discussed below, and at least one element selected from the group consisting of germanium, copper, niobium, chromium, cobalt, iron, molybdenum, tungsten, and palladium. In some embodiments, the braze alloy composition further comprises at least one of silicon and boron, often used to suppress the melting temperature or liquidus temperature of the alloy.

Some of the general terminology related to this disclosure and brazing technology can be reviewed briefly. As used herein, the term “liquidus temperature” generally refers to a temperature at which an alloy is transformed from a solid into a molten or viscous state. The liquidus temperature specifies the maximum temperature at which crystals can co-exist with the melt in thermodynamic equilibrium. Above the liquidus temperature, the alloy is homogeneous, and below the liquidus temperature, an increasing number of crystals begin to form in the melt with time, depending on the particular alloy. Generally, an alloy, at its liquidus temperature, melts and forms a seal between two components to be joined.

The liquidus temperature can be contrasted with a “solidus temperature”. The solidus temperature quantifies the point at which a material completely solidifies (crystallizes). The liquidus and solidus temperatures do not necessarily align or overlap. If a gap exists between the liquidus and solidus temperatures, then within that gap, the material consists of solid and liquid phases simultaneously (like a “slurry”).

“Sealing” is a function performed by a structure that joins other structures together, to reduce or prevent leakage through the joint between the other structures. The seal structure may also be referred to as a “seal” herein, for the sake of simplicity.

Typically, “brazing” uses a braze material (usually an alloy) having a lower liquidus temperature than the melting points of the components (i.e. their materials) to be joined. The braze material is brought slightly above its melting (or liquidus) temperature while protected by a suitable atmosphere. The braze material then flows over the components (known as wetting), and is then cooled to join the components together. As used herein, “braze alloy composition” or “braze alloy”, “braze material” or “brazing alloy”, refers to a composition that has the ability to wet the components to be joined, and to seal them. A braze alloy, for a particular application, should withstand the service conditions required, and melts at a lower temperature than the base materials; or melts at a very specific temperature.

As used herein, the term “brazing temperature” refers to a temperature to which a brazing structure is heated to enable a braze alloy to wet the components to be joined, and to form a braze joint or seal. The brazing temperature is often higher than or equal to the liquidus temperature of the braze alloy. In addition, the brazing temperature should be lower than the temperature at which the components to be joined may become chemically, compositionally, and mechanically unstable. There may be several other factors that influence the brazing temperature selection, as those skilled in the art understand.

As mentioned above, the braze composition that will form the braze alloy layer includes an active metal element that is critical for the formation of a thin reaction layer on the interface of the ceramic and the braze alloy. The thin reaction layer allows the braze alloy to wet the ceramic surface, resulting in the formation of a ceramic-metal joint/bond, which may also be referred to as an “active braze seal.”

A variety of suitable active metal elements may be used to form the active braze alloy. The selection of a suitable active metal element mainly depends on the chemical reaction with the ceramic (e.g., alumina) to form a uniform and continuous reaction layer, and the capability of the active metal element of forming an alloy with a base alloy (e.g. Cu—Ni alloy). In some preferred embodiments for the present invention, the active metal element is titanium. Other suitable examples of the active metal element include, but are not limited to, zirconium, hafnium, and vanadium. A combination of two or more active metal elements may also be used.

As described in U.S. application Ser. No. 13/538,203, for example, the presence and the amount of the active metal may influence the thickness and the quality of the thin reactive layer, which contributes to the wettability or flowability of the braze alloy, and therefore, the bond strength of the resulting joint. In some embodiments, the active metal is present in an amount less than about 10 weight percent, based on the total weight of the braze alloy. In the case of electrochemical cells of the type described herein, a suitable range is often from about 0.5 weight percent to about 5 weight percent. In some specific embodiments, the active metal is present in an amount ranging from about 1 weight percent to about 3 weight percent, based on the total weight of the braze alloy. The active metal element is generally present in small amounts suitable for improving the wetting of the ceramic surface, and forming the thin reaction layer, for example, less than about 10 microns. In the case of sodium-metal halide batteries, an excessive amount of an active metal in the brazing composition may sometimes cause or accelerate halide corrosion.

As alluded to previously, the braze alloy has a liquidus temperature lower than the melting temperatures of the components to be joined. In one embodiment, the braze alloy has a liquidus temperature of at least about 850° C., and in some instances, from about 850° C. to about 1300° C. In some specific embodiments, the liquidus temperature is from about 950° C. to about 1250° C.

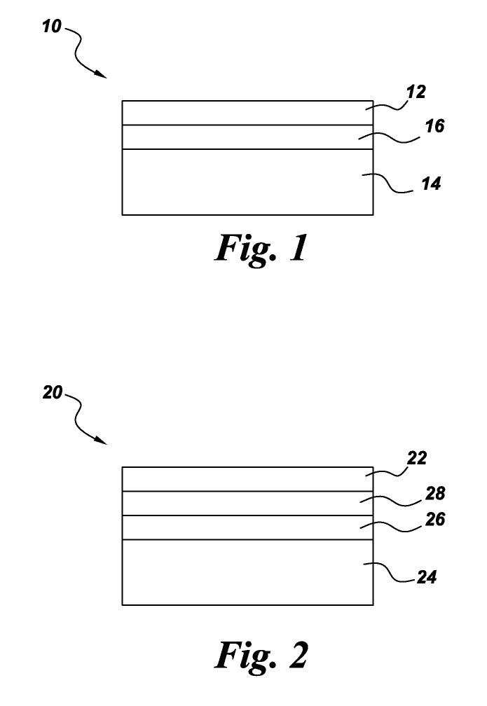

FIG. 1 is a simplified, cross-sectional depiction of a conventional brazing structure 10. The structure includes a metal component 12 (such as nickel), joined to a ceramic component 14, such as alumina, by way of intervening braze alloy layer 16. The braze alloy contains a least one active metal element, as mentioned previously. A good active braze seal can sometimes be formed between layers 12 and 14. However, as also explained previously, the migration of the active metal toward layer 12 during brazing can, in other situations, lead to a relatively weak joint between the components.

FIG. 2 is a simplified, cross-sectional depiction of a brazing structure 20, according to embodiments of the present invention. The structure includes a metal component 22, joined to a ceramic component 24, as in the case of the FIG. 1 structure, i.e., by way of intervening braze alloy layer 26. The braze alloy contains a least one active metal element, as mentioned previously.

However, in the embodiment of FIG. 2, a barrier layer 28 is disposed between metal layer 22 and the braze alloy layer 26. The barrier layer (not drawn to any specific scale in this figure) functions in preventing or minimizing the diffusion of the active metal element(s) into the metal component, during the brazing process. In this manner, a relatively strong, hermetic bond can be formed between the metal and ceramic components.

The composition of the barrier layer will depend on a number of factors, some of which are described more specifically below. In general, the factors include, for example, the specific types of materials being brazed; the other constituents that are present in the braze composition, e.g., the type of active metal; as well as the type of device or other article in which the brazing structure is to be incorporated. In some embodiments, the barrier layer comprises molybdenum (Mo), chromium (Cr), tungsten (W), or rhenium (Re). Combinations of two or more of these metals may also be used. As discussed below, in other embodiments, the barrier layer comprises molybdenum, chromium, tungsten, rhenium, niobium (Nb), tantalum (Ta), manganese (Mn), or combinations thereof. In the case of braze compositions containing titanium (or mainly titanium) as the active metal, the barrier layer often comprises molybdenum or chromium, or combinations thereof.

Moreover, in the case of braze structures for sodium/metal halide electrochemical cells, the choice of a barrier layer is greatly influenced by the material's stability, relative to the chemistry of the cell, e.g., its anti-corrosive character. The barrier layer material should not be one that will dissolve into the active metal, so as to form brittle intermetallic phases in the braze joint. The barrier layer material should also not have a tendency to form intermetallics with nickel or nickel alloys (when the metal halide is based on nickel), or to form intermetallics with the braze elements. These intermetallics can also result in poor joint strength.

Thus, the most suitable composition for the barrier layer will depend in part on the location of the braze structure, relative to an anode or cathode. With these considerations in mind, it has been determined that the barrier layer can comprise Mo, Cr, W, Re, or combinations thereof, for the cathode region of the cell, since the other elements described above may induce corrosion or other undesirable effects, as explained previously. However, in the case of the anode region of the cell, the barrier layer can comprise any of the elements (Mo, Cr, W, Re, Nb, Ta, Mn), or combinations thereof. FIG. 4, described below, provides a more specific depiction of the barrier layer in some regions of a cell structure.

The barrier layer can be positioned between the nickel component and the braze alloy layer by a number of techniques. For example, the barrier layer could be deposited by conventional techniques such as chemical vapor deposition (CVD). Alternatively, sputtering techniques could be used, as well as traditional plating techniques (electroplating or electroless plating), or physical deposition techniques. The most suitable technique will depend on the particular barrier material employed; the desired thickness for the layer; and several of the other factors set out previously.

The thickness of the barrier layer will also depend on some of the considerations noted above, including, for example, the thickness of the adjacent braze alloy layer and the nickel layer; as well as the composition of the barrier layer. In general, the barrier layer usually has a thickness in the range of about 0.1 micron to about 1,000 microns; and more often, in the range of about 10 microns to about 500 microns. In the case of a chromium or molybdenum barrier layer, used in conjunction with a titanium-based active braze material, the thickness may often be about 20 microns to about 250 microns.

As described previously, the brazing structure can be incorporated into an electrochemical cell that comprises a first component and a second component joined to each other by a braze alloy composition. The cell may be part of a thermal battery, e.g., a sodium-sulfur cell or a sodium-metal halide cell. As discussed above, the braze alloy composition may provide an active braze seal to join the components. In one embodiment, the first component of the cell comprises a metal, and the second component comprises a ceramic. The metal component can be a ring that is formed of nickel or a nickel alloy. The ceramic component can be a collar that includes an electrically insulating material, such as alpha-alumina.

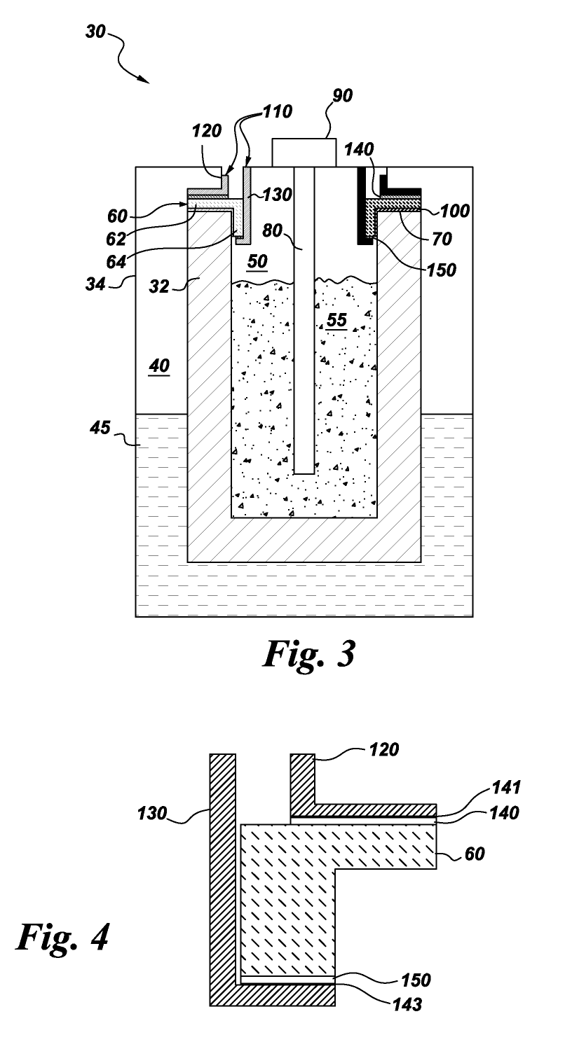

FIG. 3 is a schematic diagram depicting an exemplary embodiment of a sodium-metal halide battery cell 30 that can include one or more of the braze structures described herein. The cell 30 includes an ion-conductive separator tube 32, disposed in a cell case 34. The separator tube 32 is usually made of β-alumina or β″-alumina. The tube 32 defines an anodic chamber 40 between the cell case 34 and the tube 32, and a cathodic chamber 50, inside the tube 32. The anodic chamber 40 is usually filled with an anodic material 45, e.g. sodium. The cathodic chamber 50 contains a cathode material 55 (e.g. nickel and sodium chloride), and a molten electrolyte, such as sodium chloroaluminate (NaAlCl₄).

An electrically insulating ceramic collar 60, which may be made of alpha-alumina, is situated at a top end 70 of the separator tube 32. A cathode current collector assembly 80 is disposed in the cathode chamber 50, with a cap structure 90, in the top region of the cell. The ceramic collar 60 is fitted onto the top end 70 of the separator tube 20, and is sealed by a glass seal 100. In one embodiment, the collar 60 includes an upper portion 62, and a lower inner portion 64 that abuts against an inner wall of the tube 32, as illustrated in FIG. 3.

In order to seal the cell 30 at the top end (i.e., its upper region), and protect the alumina collar 60 in the corrosive environment, a metal ring 110 is sometimes disposed, covering the alpha alumina collar 60, and joining the collar with the current collector assembly 80, underneath the cap structure 90. The metal ring 110 usually has two portions; an outer metal ring 120 and an inner metal ring 130, which are joined, respectively, with the upper portion 62 and the lower portion 64 of the ceramic collar 60, by means of the active braze seals 140 and 150 (FIG. 4). The active braze seal 140, the seal 150, or both, may be formed by using one of the suitable braze alloy compositions described above. The collar 60 and the metal ring 110 may be temporarily held together with an assembly (e.g., a clamp), or by other techniques, until sealing is complete.

The outer metal ring 120 and the inner metal ring 130 are usually welded shut to seal the cell, after joining with the ceramic collar 60 is completed. The outer metal ring 120 can be welded to the cell case 34; and the inner metal ring 130 can be welded to the current collector assembly 80.

The shape and size of the several components discussed above with reference to FIG. 3 are only illustrative for the understanding of the cell structure; and are not meant to limit the scope of the invention. The exact position of the seals and the joined components can vary to some degree. Moreover, each of the terms “collar” and “ring” is meant to comprise metal or ceramic parts of circular or polygonal shape, and in general, all shapes that are compatible with a particular cell design.

FIG. 4 is a schematic view, depicting a portion of FIG. 3, in greater detail, so as to show one exemplary region in which the braze structure can be incorporated into an electrochemical cell. As described previously, the ceramic collar 60 can be fitted at the top end of a separator/electrolyte tube, not specifically shown in this figure. A metal ring 120 is positioned to seal the top end of the structure, and must be securely attached to the collar. The active braze alloy 140 is used for this purpose. In line with the inventive embodiments, a barrier layer 141 is disposed between the metal ring 120 and the ceramic collar 60. The barrier layer prevents migration of active elements into the metal ring. It should be emphasized that there are other regions within the cell, wherein the barrier layer can be used effectively in conjunction with a braze structure, e.g., 143.

In general, braze alloys (e.g., the braze alloy layer) and the active braze seal formed thereof, generally have good stability and chemical resistance within determined parameters at a determined temperature. In the case of electrochemical cells, it is desirable (and in some cases, critical) that the braze seal retains its integrity and properties during several processing steps while manufacturing and using the cell, for example, during a glass-seal process for a ceramic-to-metal joint, and during operation of the cell.

In some instances, optimum performance of the electrochemical cell is generally obtained at a temperature greater than about 300° C. In one embodiment, the operating temperature may be in a range from about 270° C. to about 450° C. In one embodiment, the glass-seal process is carried out at a temperature of at least about 1000° C. In some other embodiments, the glass-seal process is carried out in a range of from about 1000° C. to about 1200° C. Moreover, the bond strength and hermeticity of the seal may depend on several parameters, such as the composition of the braze alloy, the thickness of the thin reaction layer, the composition of the metal and the ceramic, and the surface properties of the ceramic. The use of the barrier layer within the brazing structure is an important feature in enhancing the strength and integrity of the seal(s) within the cells.

According to some embodiments of this invention, an energy storage device is provided. The device includes a plurality of the electrochemical cells as described herein. The cells are, directly or indirectly, in thermal and/or electrical communication with each other. Those of ordinary skill in the art are familiar with the general principles of such devices.

As mentioned previously, another embodiment of the invention is directed to a method for joining a metallic component to a ceramic component in a device or other type of article. The method includes the step of applying a barrier layer to at least a portion of the surface of the metallic component (often made of nickel or a nickel alloy)—a portion sufficient to allow the formation of the desired seal for containing or isolating various solids, liquids, or gases. An active metal-containing braze alloy composition can then be introduced between the barrier layer and the ceramic component to be joined, forming a layer of the braze. The components are then heated with the braze material to form an active braze seal (i.e., a joint) between them. The use of the barrier layer in this process to restrict the migration of the active metal often leads to the high-quality seal described previously.

### EXAMPLES

The examples that follow are merely illustrative, and should not be construed to be any sort of limitation on the scope of the claimed invention. Unless specified otherwise, all ingredients may be commercially available from such common chemical suppliers as Alpha Aesar, Inc. (Ward Hill, Mass.), Sigma Aldrich (St. Louis, Mo.), Spectrum Chemical Mfg. Corp. (Gardena, Calif.), and the like.

### Example 1

A braze alloy composition was prepared, by weighing out the individual constituents according to the selected proportions, to form a paste-composition, as follows:

Cu-3Si-2Al-2.25 Ti, in the shape of pre-forms; and Cu-3Si-2Al-13Ti, in the form of powder. The composition had a liquidus temperature of approximately 1024° C.

The braze composition was used to join a nickel ring to an alumina collar, i.e., as depicted in simple form, in FIG. 1. Brazing was carried out at 1100° C., for 15 minutes. The resulting braze structure (Sample 1) was then allowed to cool to room temperature.

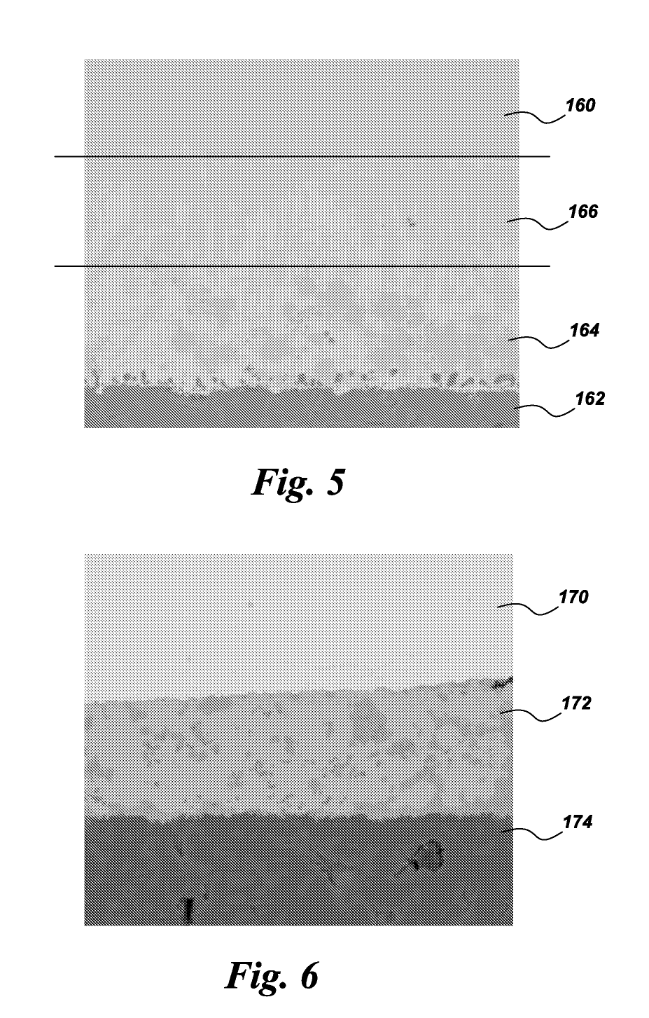

The quality of the braze structure was then evaluated. The test-piece was cross-sectioned; and the interface between the alumina and nickel plates was examined, using scanning electron microscopy (SEM). FIG. 5 is the cross-sectional micrograph, showing nickel layer 160 and alumina layer 162, as well as braze alloy layer 164. However, an interdiffusional region generally depicted at 166 was also present; which contained a relatively large concentration of the active metal, titanium, relative to the proportion of titanium present in layer 164. The excessive titanium diffusion into region 166 appears to be detrimental to the quality of the active braze joint, as discussed previously.

The same type of braze composition was then used to form the Sample 2 braze structure, depicted in the scanning electron micrograph of FIG. 6. In this instance, a molybdenum barrier layer, having an average thickness of about 100 microns, was introduced between the braze alloy and a nickel plate, in the form of a 100 micron-thick molybdenum foil. The braze alloy layer was then applied over the molybdenum foil. This was followed by the application of an alumina layer. Brazing was again carried out at 1100° C., for 15 minutes. The resulting braze structure (Sample 2) was then allowed to cool to room temperature.

The quality of this braze structure was then evaluated. The test-piece for Sample 2 was cross-sectioned; and the interface between the alumina and nickel plates was examined, using scanning electron microscopy (SEM). FIG. 6 is the cross-sectional micrograph, magnified to focus in on the comparative region, relative to FIG. 5. The molybdenum barrier layer 170 is depicted, plated over the nickel layer (not specifically shown here, but disposed above the top section of the figure). Braze alloy layer 172 is situated between the barrier layer 170 and the alumina plate 174. The figure shows a very clean interface between the braze layer 172 and the barrier layer 170. This is an indication that there was little, if any diffusion of the titanium through the barrier layer, i.e., in the direction of the metallic nickel layer. As described above, a greater portion of the active metal is then able to interact with the alumina material, and this can ensure an active braze joint with greater integrity.

The present invention has been described in terms of some specific embodiments. They are intended for illustration only, and should not be construed as being limiting in any way. Thus, it should be understood that modifications can be made thereto, which are within the scope of the invention and the appended claims. Furthermore, all of the patents, patent applications, articles, and texts which are mentioned above are incorporated herein by reference.

What is claimed:

1. A brazing structure, comprising
a) a nickel or nickel alloy component;
b) a ceramic component;
c) a braze alloy layer disposed between components (a) and (b), and formed of a composition comprising an active metal element; and
d) a barrier layer disposed between component (a) and the braze alloy layer, capable of preventing or minimizing the diffusion of the active metal element into the nickel or nickel alloy component.

2. The brazing structure of claim 1, wherein the braze alloy composition comprises nickel, the active metal element, and at least one element selected from the group consisting of germanium, copper, niobium, chromium, cobalt, iron, molybdenum, tungsten, and palladium.

3. The brazing structure of claim 1, wherein the braze alloy composition comprises at least one of silicon and boron.

4. The brazing structure of claim 1, wherein the active metal element comprises titanium, zirconium, hafnium, vanadium, or a combination thereof.

5. The brazing structure of claim 4, wherein the active metal element is titanium.

6. The brazing structure of claim 1, wherein the barrier layer comprises molybdenum, chromium, tungsten, rhenium, niobium, tantalum, manganese, or combinations thereof.

7. The brazing structure of claim 1, wherein the barrier layer comprises molybdenum, chromium, tungsten, rhenium, or combinations thereof.

8. The brazing structure of claim 1, wherein the barrier layer has a thickness in the range of about 0.1 micron to about 1,000 microns.

9. The brazing structure of claim 1, wherein the ceramic component comprises aluminum oxide (alumina).

10. The brazing structure of claim 1, contained within a thermal battery.

11. The brazing structure of claim 10, wherein the thermal battery is a sodium metal halide battery or a sodium-sulfur battery.

12. The brazing structure of claim 11, wherein the ceramic component is a collar structure attached to one portion of a separator tube in the battery.

13. The brazing structure of claim 11, wherein the metal component is a metal ring, attached to at least one current collector assembly in the battery.

14. The brazing structure of claim 13, comprising a hermetic seal between the collar structure and the current collector assembly, wherein the hermetic seal is capable of containing all electrode materials within desired interior regions of the battery.

15. An electrochemical cell, including a ceramic component and a metallic component that comprises nickel or a nickel alloy, wherein the components are joined to each other by a braze alloy layer that includes an active metal element, and wherein a barrier layer is disposed between the metallic component and the braze alloy layer, said barrier layer being capable of preventing or minimizing the diffusion of the active metal element into the metallic component.

16. The electrochemical cell of claim 15, comprising an anode region, a cathode region, and a separator region between the anode region and the cathode region; wherein the cathode region includes a ceramic structure and an adjacent metal ring, joined together by the braze alloy layer; and wherein the barrier layer comprises molybdenum, chromium, tungsten, rhenium, or combinations thereof.

17. An energy storage device, comprising a plurality of electrochemical cells according to claim 15.

18. A method of joining a nickel or nickel alloy (metallic) component in a thermal battery to a ceramic component in the battery, comprising the steps of:
(I) applying a barrier layer to at least a portion of the surface of the metallic component;
(II) introducing an active metal-containing braze alloy composition between the barrier layer and the ceramic component to be joined; and
(III) heating the components and the braze alloy composition to form an active braze seal between the metallic component and the ceramic component;
wherein the barrier layer is capable of preventing or minimizing the diffusion of the active metal into the metallic component.

19. The method of claim 18, wherein the barrier layer is applied to the metallic component by a technique selected from the group consisting of physical vapor deposition, chemical vapor deposition, sputtering, and plating processes.

20. The method of claim 18, wherein the heating in step (III) is carried out at a brazing temperature that is greater than or equal to the liquidus temperature of the braze alloy composition; and less than the melting temperatures of the components to be joined.
